(19) United States
(12) Patent Application Publication
(10) Pub. No.: US 2019/0124893 A1
(43) Pub. Date: May 2, 2019

(54) AQUATIC ANIMAL IDENTIFICATION AND PASSAGE CONTROL DEVICE

(71) Applicant: Aviantronics, LLC, Gun Barrel City, TX (US)

(72) Inventor: Pat M. Bolen, Gun Barrel City, TX (US)

(21) Appl. No.: 16/176,999

(22) Filed: Oct. 31, 2018

Related U.S. Application Data
(60) Provisional application No. 62/579,712, filed on Oct. 31, 2017.

(51) Int. Cl. A01K 61/90; G06K 9/00; G07C 9/00

(52) U.S. Cl. CPC A01K 61/90; G07C 9/00158; G06K 9/00369

(57) ABSTRACT

An automated aquatic animal processing device includes an aquatic animal guideway, a camera positioned proximate to the aquatic animal guideway, a data storage containing one or more aquatic animal reference image, a processor communicably coupled to the camera and the data storage, and a power supply connected to the camera, the processor and the data storage. The camera captures a target image of an aquatic animal entering, within or exiting the aquatic animal guideway. The processor receives the target image from the camera, determine an identity of the aquatic animal by comparing the target image to the one or more aquatic animal reference images, and causes the aquatic animal to be captured, exterminated/euthanized or released based on the identity of the aquatic animal.

### CROSS-REFERENCE TO RELATED APPLICATIONS

This application is a non-provisional patent application of and claims priority to U.S. provisional patent application Ser. No. 62/579,712 filed Oct. 31, 2017 and entitled “Aquatic Animal Identification and Passage Control Device”, the contents of which are hereby incorporated by reference in their entirety.

This patent application is related to U.S. patent application Ser. No. 14/889,368 filed on May 9, 2013, and entitled “Species Specific Extermination Device,” which is a U.S. national phase application of the PCT international application no. PCT/US2014/037466 filed on May 9, 2013 and entitled “Species Specific Extermination Device,” which is a PCT international application of U.S. provisional application filed on 61/821,517 and entitled “Species Specific Extermination Device.” All of the foregoing applications are hereby incorporated by reference in their entirety.

### TECHNICAL FIELD OF THE INVENTION

The present invention relates generally to methods and devices used in identifying animals and more specifically to capturing, exterminating, allowing passage, or preventing passage of selected aquatic animals.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

While some fish may be attractive and of a positive benefit, there are other fish that are destructive or at least undesirable. For example, Asian carp are fresh water fish that have been cultivated in China for years, but now some varieties are found in the US waterways and are having a detrimental effect on native fish, snail, clam, plant and plankton species. The most common Asian carp now found in large numbers are bighead, silver, black and grass carp. Bighead and silver carp feed by filtering plankton from the water, and cause competition for food among US native species including competition for living space. In addition, because of their filter-feeding habits, they are difficult to capture by normal angling methods. Moreover, Asian carp reproduce quickly, are fast growing and have few natural predators.

In July, 2007, the U.S. Department of the Interior declared all silver carp and largescale silver carp to be injurious species, and deployed strategies to protect the Great Lakes from Asian carp. One such strategy was the deployment of electric barrier systems in waterways connected to the Great Lakes to restrict or attempt to prevent the movement of Asian carp or other invasive fish into the Great Lakes.

For example, U.S. Pat. No. 6,978,734 discloses an electric fish barrier for deterring fish from entering a water intake in a reservoir or along a waterway. The electric fish barrier uses a first set of conductive members at a first voltage potential and a second set of conductive members at a second voltage potential to deter the fish from following the attraction flow into a water intake. Likewise, U.S. Patent Application Publication No. 2015/0196012 describes an electrical barrier with a computer system and a bio-electric fish proximity detector for deterring fish. Electrofishing uses electric currents to attract and/or repel fish.

Moreover, U.S. Pat. No. 9,370,194 describes a method of slaughtering fish by providing an elongated passage and generating linear electric fields in the water inside the passage to stun and subsequently kill the fish.

In addition, fish traps can be used to remove invasive species. For example, U.S. Pat. No. 8,919,034 describes a fish trap system that includes an enclosure having a revolving trap door attached to a coned gate Gargoor. Still and video cameras are included in the enclosure to provide snapshot and moving pictures of fish caught in the trap. User-controlled electrical gates are provided to either retain a fish or release a fish by closing and opening the gates via the Internet connection.

All of the foregoing applications are hereby incorporated by reference in their entirety.

### SUMMARY OF THE INVENTION

In one embodiment, the present invention provides an automated aquatic animal processing device that includes an aquatic animal guideway, a camera positioned proximate to the aquatic animal guideway, a data storage containing one or more aquatic animal reference image, a processor communicably coupled to the camera and the data storage, and a power supply connected to the camera, the processor and the data storage. The camera captures a target image of an aquatic animal entering, within or exiting the aquatic animal guideway. The processor receives the target image from the camera, determines an identity of the aquatic animal by comparing the target image to the one or more aquatic animal reference images, and causes the aquatic animal to be captured, exterminated/euthanized or released based on the identity of the aquatic animal.

In another embodiment, the present invention provides a method for automatically processing an aquatic animal by providing an aquatic animal guideway, a camera positioned proximate to the aquatic animal guideway, a data storage containing one or more aquatic animal reference images, a processor communicably coupled to the camera and the data storage, and a power supply connected to the camera, the processor and the data storage; capturing a target image of an aquatic animal entering, within or exiting the aquatic animal guideway; determining an identity of the aquatic animal by comparing the target image to the one or more aquatic animal reference images; and capture, exterminate, allow passage, and/or prevent passage of the aquatic animal based on the identity of the aquatic animal.

### BRIEF DESCRIPTION OF THE DRAWINGS

For a more complete understanding of the features and advantages of the present invention, reference is now made to the detailed description of the invention along with the accompanying figures and in which:

FIG. 1 is a block diagram of an aquatic animal identification and passage control system in accordance with one embodiment of the present invention;

FIG. 2 is a flow chart of a method for identifying and processing aquatic animals in accordance with one embodiment of the present invention;

FIG. 3 is a diagram of another embodiment of the present invention;

FIG. 4 is a bock diagram of a system in accordance with one embodiment of the present invention; and

FIG. 5 is a block diagram of a system in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention provides a device and method that allows the automated real-time identification of an aquatic animal and controls one or more components to capture, exterminate, allow passage, and/or prevent passage of the aquatic animal if certain criteria are met. Generally the device operates in connection with one or more aquatic animal guideways or passages. A camera is positioned proximate to the aquatic animal guideway to capture a target image of an aquatic animal entering, within or exiting the aquatic animal guideway. In some cases, the camera is positioned within an aquatic enclosure connected to the aquatic animal guideway. A processor determines an identity of the aquatic animal by comparing the target image to the one or more aquatic animal reference images, and causes the aquatic animal to be captured, exterminated/euthanized or released by controlling other components (e.g., physical gates, pulse generators connected to electrodes, etc.). Specific aquatic animals can be allowed or prevented from entering the aquatic animal guideway or aquatic enclosure using physical gates or electric barriers functioning as gates. Likewise, specific aquatic animals can be allowed or prevented from the exiting aquatic animal guideway or aquatic enclosure using physical gates or electric barriers functioning as gates. Moreover, specific aquatic animals can be stunned, exterminated/euthanized or diverted using electrodes. In some cases, but probably not Asian carp, a bait placed within the aquatic animal guideway or aquatic enclosure can be used to lure aquatic animals into the aquatic animal guideway or aquatic enclosure.

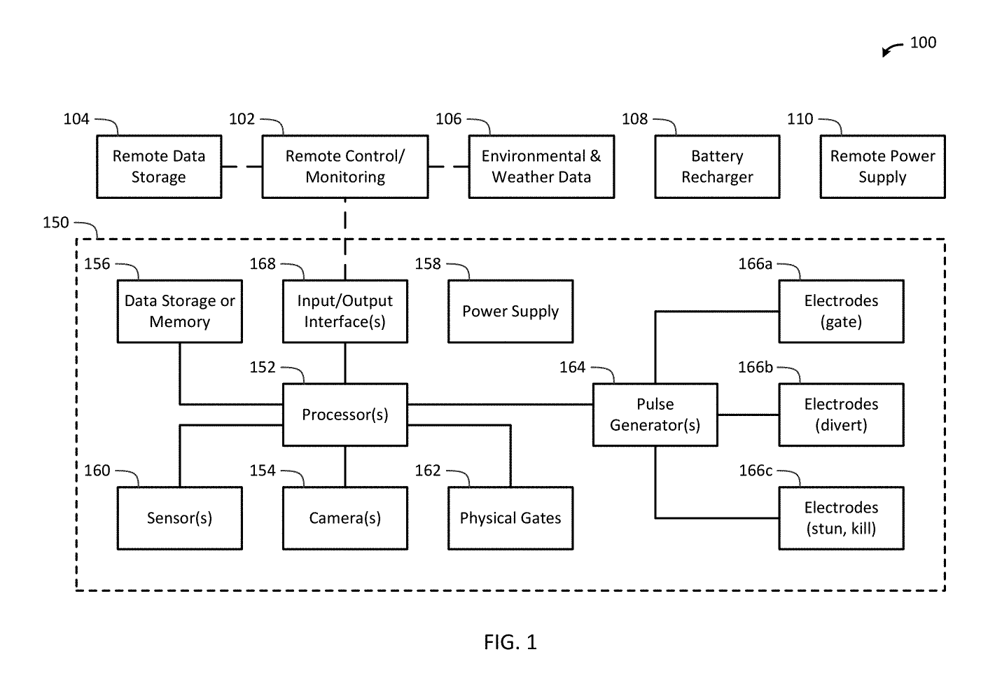

Now referring to FIG. 1, a block diagram of an aquatic animal identification and passage control system 100 in accordance with one embodiment of the present invention is shown. The system 100 includes one or more aquatic animal identification and passage control devices 150 that can operate independently as a stand-alone unit or as part of a larger barrier or passage control system. Each device 150 minimally includes a processor 152, a camera 154 communicably coupled to the processor 152, a data storage or memory 156 communicably coupled to the processor 152, and a power supply 158 connected to the processor 152, camera 154, and data storage or memory 156. Note that the data storage or memory 156 can be integrated into the processor 152, and the processor 152 can be programmable controller, etc. Moreover, the processor 152, data storage or memory 156 and power supply 158 will typically be contained in a watertight enclosure proximate to the camera 154, or located above the water surface, or on shore. In some embodiments, the processor 152, camera 154, data storage or memory 156, and power supply 158 are integrated into a single watertight enclosure. As previously described and depending on how the device 150 is used, the camera 154 is positioned proximate to an aquatic animal guideway (not shown) to capture a target image of an aquatic animal entering, within or exiting the aquatic animal guideway (now shown). In some cases, the camera 154 is positioned within an aquatic enclosure (not shown) connected to the aquatic animal guideway (not shown).

The device 150 may also include one or more sensors 160 that are used to detect the presence or movement of the aquatic animal. The one or more sensors 160 can be used to selectively turn on or turn off (sleep mode) the device 150, the camera 154 or other components to conserve power. The one or more sensors 160 may include a thermal imaging sensor, a temperature sensor, a humidity sensor, a weather related sensor, a proximity sensor, a water speed sensor, a water temperature sensor, a depth sensor, and/or other types of sensors that are known to the skilled artisan to record any type of data. The processor 152 can use information from the one or more sensors 160 to control other components. Depending on the configuration and purpose of the device 150, one or more physical gates 162 (typically motor operated), or pulse generator(s) 164 with electrodes 166a (electric gate), 166b (divert), 166c (stun, exterminate/euthanize) are communicably coupled to the processor 152 to capture, exterminate, allow passage, and/or prevent passage of the aquatic animal. For example, an invasive species (e.g., Asian carp, etc.) can be captured, exterminated or prevented passage, while a native non-invasive species can be allowed passage or prevented passage. The device 150 may also include one or more input/output interfaces 168 communicably coupled to the processor 152. In addition, a tissue sampler can be use to take a tissue or scale sample from the aquatic animal, and may be used independently of the euthanization feature. For example, the tissue sampler can be in the form of a biopsy needle is positioned to remove a sample from the aquatic animal. The camera records an image of the fish and the image is processed to determine if extermination/euthanization is necessary. A sample is then taken and the fish released or euthanized.

The system 100 may include a remote control or monitoring device 102 communicably coupled to the input/output interface 168 of the device 150. A remote data storage 104 can be communicably coupled to the remote control or monitoring device 102 or the input/output interface 168 of the device 150. Likewise, a source of environmental and/or weather data 106 can be communicably coupled to the remote control or monitoring device 102 or the input/output interface 168 of the device 150. The system 100 or device 150 may include a battery recharger 108 connected to the power supply 158 or pulse generator(s) 164. In some embodiments, battery recharger 108 can be based on one or more of solar energy, water flow energy, wind energy, etc. In other embodiments, a remote power supply 110 can be used to power the pulse generator(s) 164 and electrodes 166a-c.

In some embodiments, the aquatic animal guideway is cone shaped or cylindrical shaped and can lead into an aquatic enclosure, past a barrier or into another waterway (e.g., containment pond, etc.). The aquatic animal guideway or the aquatic enclosure can be connected to other aquatic animal guideways or aquatic enclosures, and may include one or more physical gates 162 or electrode gates 166a controlled by the processor 152. In some embodiments, the processor 152 stores the target image and an associated data in the data storage 156, or transmits the images and data to the remote control or monitoring devices 102 or remote data storage 104 via the input/output interface 168. The associated data may include a geographic data, a time, a date, the identity of the aquatic animal, or other desired information.

The aquatic animal guideway or the aquatic enclosure can also be part of a physical barrier, wall or electronic barrier. For example, an electric barrier system can be disposed over the device 150 and aquatic animal guideway or the aquatic enclosure, such as a controlled passageway through the electric barrier is provided. The aquatic animal guideway or the aquatic enclosure can be grounded to form a Faraday cage to protect the electronics from interference from the electric barrier. The passageway through the electric barrier can be one-way or two-way. Moreover, the passageway can have multiple branches to direct invasive species to holding or containment ponds or enclosures for removal, relocation or disposal of the invasive species, and allow native species through the electronic barrier.

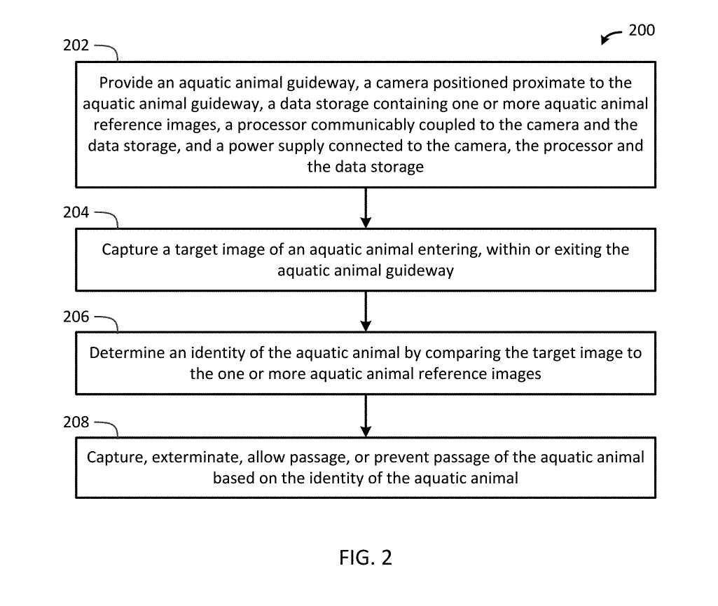

Referring now to FIG. 2, a flow chart of a method 200 for identifying and processing aquatic animals in accordance with one embodiment of the present invention is shown. An aquatic animal guideway, a camera positioned proximate to the aquatic animal guideway, a data storage containing one or more aquatic animal reference images, a processor communicably coupled to the camera and the data storage, and a power supply connected to the camera, the processor and the data storage are provided in block 202. A target image of an aquatic animal entering, within or exiting the aquatic animal guideway is captured in block 204. An identity of the aquatic animal is determined by comparing the target image to the one or more aquatic animal reference images in block 206. The aquatic animal is captured, exterminated, allowed passage, and/or prevented passage based on the identity of the aquatic animal in block 208.

The method 200 may include additional steps, such as detecting the aquatic animal using a sensor communicably coupled to the camera and/or the processor, and storing the target image and an associated data (e.g., a geographic data, a time, a date, the identity of the aquatic animal, or a combination thereof) in the data storage. In one embodiment, a gate operably connected to an end of the aquatic animal guideway and controlled by the processor is provided, and the gate is opened or closed based on the identity of the aquatic animal or a loss of power to the camera or the processor. In another embodiment, a plurality of electrodes are provided within the aquatic animal guideway and controlled by the processor, and the aquatic animal is deterred or prevented from passing through the aquatic animal guideway, the aquatic animal is stunned, or the aquatic animal is exterminated/euthanized using the plurality of electrodes based on the identity of the aquatic animal. Similarly, the plurality of electrodes can be provided within the enclosure and controlled by the processor, and the aquatic animal is stunned, or the aquatic animal is exterminated/euthanized using the plurality of electrodes based on the identity of the aquatic animal. Additional, aquatic animal guideways, enclosures and/or gates can be provided.

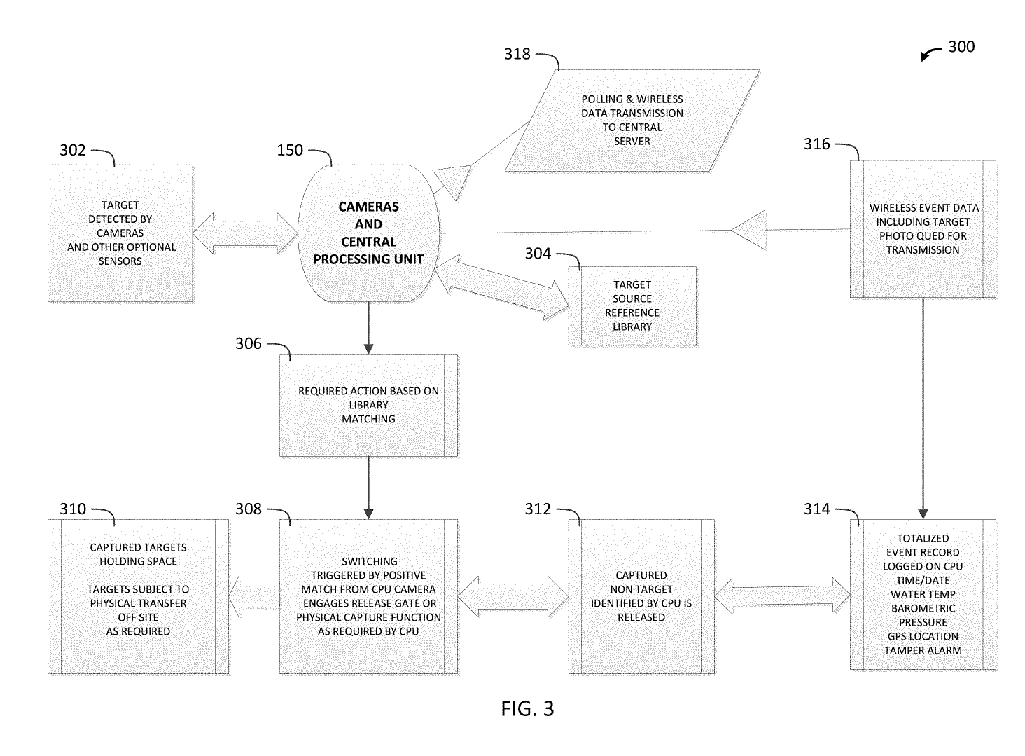

Now referring to FIG. 3, a diagram of another embodiment 300 of the present invention is shown. A target is detected by cameras or other optional sensors in block 302. The cameras and central processing unit 150 checks the image against a target source reference library 304 and determines are required action based on library matching in block 306. Switching is triggered by a positive match from the CPU camera that engages a release gate or physical capture function as required by the CPU in block 308. Captured targets are held in a holding space and are subject to physical transfer off site as required in block 310. Captured non-targets identified by the CPU are released in block 312. The totalized event record is logged on the CPU (e.g., time/date, water temperature, barometric pressure, geographic location, tamper alarm, etc.) in block 314. The event data including target photo is queued for wireless transmission (real time or batch) in block 316. The CPU wirelessly polls and transmits data to a central server in block 318.

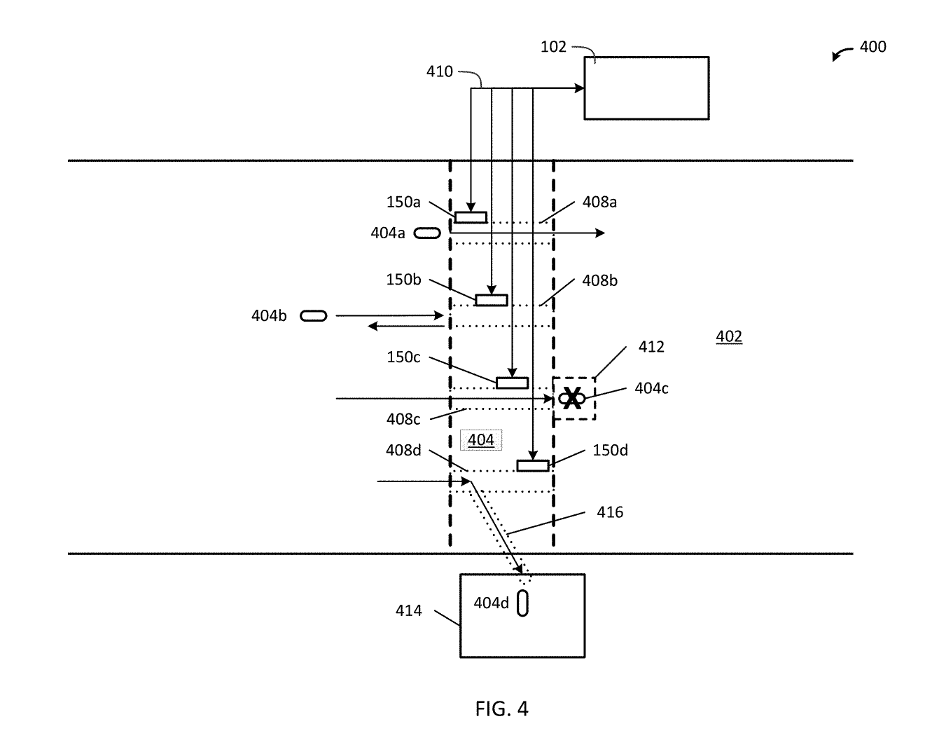

Referring now to FIG. 4, a block diagram of a system 400 in accordance with one embodiment of the present invention is shown. The system 400 includes a river, stream, channel, canal, or other aquatic body 402 containing aquatic animals 404a, 404b, 404c, 404d, and an aquatic animal barrier 406. The aquatic animal barrier 406 can be a physical barrier or system of barriers, or an electric barrier or system of barriers, or a combination thereof, including, but not limited to those described above in the background. The aquatic animal barrier 406 may or may not allow boats to pass. The aquatic animal barrier 406 includes one or more physical or electric aquatic animal guideways or passages 408a, 408b, 408c, 408d, or a combination thereof, which allow or prevent aquatic animals 404a, 404b, 404c, 404d from passing through the aquatic animal barrier 406 as controlled by aquatic animal identification and passage control devices 150a, 150b, 150c, 150d. The aquatic animal identification and passage control devices 150a, 150b, 150c, 150d can operate independently or via remote control/monitoring device 102. The aquatic animal identification and passage control devices 150a, 150b, 150c, 150d can be communicably coupled to the remote control/monitoring device 102 via physical or wireless communication links 410, or a combination thereof. Note that when the aquatic animal guideways 408a, 408b, 408c, 408d are physical aquatic animal guideways, they can be cone shaped or cylindrical shaped or any other suitable shape.

FIG. 4 illustrates four different scenarios: (1) the aquatic animal 404a is allowed to pass through the aquatic animal barrier 406 via aquatic animal guideway 408a; (2) the aquatic animal 404b is prevented from passing through the aquatic animal barrier 406 and turns around; (3) the aquatic animal 404c is prevented from exiting the aquatic animal barrier 406 and is captured in a first aquatic enclosure 412 connected to aquatic animal guideway 408c; and/or (4) the aquatic animal 404d is prevented from exiting the aquatic animal barrier 406 and is diverted for capture in second aquatic enclosure 414 via second aquatic animal guideway 416. Note that any one of these four scenarios or a combination thereof can be implemented. A gate can be operably connected to an end of the aquatic animal guideways 408a, 408b, 408c, 408d. Alternatively, the gate can be connected to the start of aquatic animal guideways 408a, 408b, 408c, 408d, or somewhere in between the start and end. In addition, first aquatic enclosure 412 and/or second aquatic enclosure 414 can be equipped with gates. Captured aquatic animals 404c, 404d can be held for relocation or disposal. Moreover, captured aquatic animals 404c, 404d can be stunned or euthanized via electrodes.

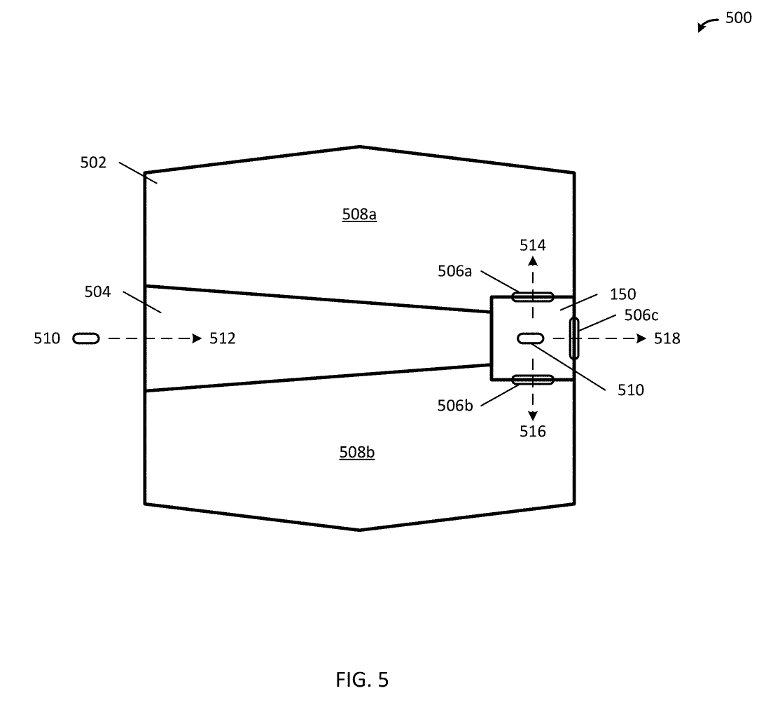

Now referring to FIG. 5, a block diagram a system 500 in accordance with one embodiment of the present invention is shown. In this embodiment, an aquatic enclosure or trap 502 includes an aquatic animal guideway 504 and a passage control devices 150. The passage control device 150 can control one or more physical or electric gates 506a, 506b, 506c. Physical or electric gates 506a and 506b can lead into the same aquatic enclosure or trap 502 or separate compartments 508a and 508b, respectively, within aquatic enclosure or trap 502. Physical or electric gate 506c opens to the outside of aquatic enclosure or trap 502. The passage control device 150 identifies aquatic animals 510 that enter (arrow 512) aquatic animal guideway 504, and either divert them into the release them into aquatic enclosure or trap 502 via physical or electric gates 506a (arrow 514) and/or 506b (arrow 516), or allow them to exit the aquatic enclosure or trap 502 via physical or electric gate 506c (arrow 518). As previously discussed, the passage control device 150 can also stun or euthanize the aquatic animals 510 at the identification point, the gates 506a, 506b or within the aquatic enclosure or trap 502. The passage control device 150 can also segregate different species of aquatic animals 510 for study and later release or relocation.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. An automated aquatic animal processing device comprising:
an aquatic animal guideway;
a camera positioned proximate to the aquatic animal guideway to capture a target image of an aquatic animal entering, within or exiting the aquatic animal guideway;
a data storage containing one or more aquatic animal reference images;
a processor communicably coupled to the camera and the data storage, wherein the processor receives the target image from the camera, determines an identity of the aquatic animal by comparing the target image to the one or more aquatic animal reference images, and causes the aquatic animal to be captured, exterminated/euthanized or released based on the identity of the aquatic animal; and
a power supply connected to the camera, the processor and the data storage.

2. The device of claim 1, wherein the aquatic animal guideway is cone shaped or cylindrical shaped.

3. The device of claim 1, further comprising a sensor communicably coupled to the camera and/or the processor.

4. The device of claim 1, wherein one or more of the data storage, the processor and the one or more power supplies are remotely located with respect to the camera.

5. The device of claim 1, further comprising a gate operably connected to an end of the aquatic animal guideway and controlled by the processor.

6. The device of claim 1, further comprising a plurality of electrodes within the aquatic animal guideway and controlled by the processor to deter the aquatic animal from passing through the aquatic animal guideway, stun the aquatic animal, or exterminate/euthanize the aquatic animal.

7. The device of claim 1, wherein the processor stores the target image and an associated data in the data storage.

8. The device of claim 8, wherein the associated data comprises a geographic data, a time, a date, the identity of the aquatic animal, or a combination thereof.

9. The device of claim 1, wherein the aquatic animal comprises an invasive species of aquatic animal.

10. The device of claim 1, further comprising an aquatic enclosure connected to the aquatic animal guideway.

11. The device of claim 10, further comprising a plurality of electrodes within the enclosure and controlled by the processor to stun the aquatic animal, or exterminate/euthanize the aquatic animal.

12. The device of claim 10, wherein the aquatic animal guideway comprising a first aquatic animal guideway, and further comprising:
a second aquatic animal guideway connected to the aquatic enclosure; and
a gate operably connected to the second aquatic animal guideway and controlled by the processor.

13. The device of claim 10, further comprising a gate operably connected to the enclosure and controlled by the processor.

14. A method for automatically processing an aquatic animal comprising:
providing an aquatic animal guideway, a camera positioned proximate to the aquatic animal guideway, a data storage containing one or more aquatic animal reference images, a processor communicably coupled to the camera and the data storage, and a power supply connected to the camera, the processor and the data storage;
capturing a target image of an aquatic animal entering, within or exiting the aquatic animal guideway;
determining an identity of the aquatic animal by comparing the target image to the one or more aquatic animal reference images; and
capture, exterminate, allow passage, and/or prevent passage of the aquatic animal based on the identity of the aquatic animal.

15. The method of claim 14, wherein the aquatic animal guideway is cone shaped or cylindrical shaped.

16. The method of claim 14, further comprising detecting the aquatic animal using a sensor communicably coupled to the camera and/or the processor.

17. The method of claim 14, wherein one or more of the data storage, the processor and the one or more power supplies are remotely located with respect to the camera.

18. The method of claim 14, further comprising:
providing a gate operably connected to an end of the aquatic animal guideway and controlled by the processor; and
opening or closing the gate based on the identity of the aquatic animal or a loss of power to the camera or the processor.

19. The method of claim 14, further comprising:
providing a plurality of electrodes within the aquatic animal guideway and controlled by the processor; and
deterring the aquatic animal from passing through the aquatic animal guideway, stunning the aquatic animal, or exterminating/euthanizing the aquatic animal using the plurality of electrodes based on the identity of the aquatic animal.

20. The method of claim 14, further comprising storing the target image and an associated data in the data storage.

21. The method of claim 20, wherein the associated data comprises a geographic data, a time, a date, the identity of the aquatic animal, or a combination thereof.

22. The method of claim 14 wherein the aquatic animal comprises an invasive species of aquatic animal.

23. The method of claim 14, further comprising providing an aquatic enclosure connected to the aquatic animal guideway.

24. The method of claim 23, further comprising:
providing a plurality of electrodes within the enclosure and controlled by the processor; and
stunning the aquatic animal, or exterminating/euthanizing the aquatic animal using the plurality of electrodes based on the identity of the aquatic animal.

25. The method of claim 23, wherein the aquatic animal guideway comprising a first aquatic animal guideway, and further comprising:
providing a second aquatic animal guideway connected to the aquatic enclosure; and
providing a gate operably connected to the second aquatic animal guideway and controlled by the processor.

26. The method of claim 23, further comprising providing a gate operably connected to the enclosure and controlled by the processor.
